(19) United States
(12) Patent Application Publication
(10) Pub. No.: US 2025/0051528 A1
(43) Pub. Date: Feb. 13, 2025

(54) CROSSLINKABLE OLEFIN/SILANE INTERPOLYMER COMPOSITIONS WITH REDUCED PEROXIDE LEVELS

(71) Applicant: Dow Global Technologies LLC, Midland, MI (US)

(72) Inventors: Yunfeng Yang, Shanghai (CN); Yabin Sun, Shanghai (CN); Colin Li Pi Shan, Pearland, TX (US); Gaoxiang Wu, Houston, TX (US); Wenxin Zhang, Shanghai (CN)

(21) Appl. No.: 18/719,488

(22) PCT Filed: Dec. 17, 2021
(86) PCT No.: PCT/CN2021/139002

§ 371 Date: Jun. 13, 2024

(51) Int. Cl. C08J 3/24; C08K 5/14; C08K 5/549

(52) U.S. Cl. CPC C08J 3/24; C08K 5/14; C08K 5/549; C08J 2343/04

(57) ABSTRACT

A process to form a crosslinked composition, the process comprising thermally treating a composition that comprises the following components: a) at least one olefin/silane interpolymer comprising at least one Si—H group, b) at least one peroxide, and c) at least one crosslinking coagent, wherein the composition has a mole ratio of active oxygen atom to carbon-carbon double bond of ≥0.02 and ≤0.7, based on the active oxygen atom content of component b and the carbon-carbon double bond content of component c. A composition that comprises the following components: a) at least one olefin/silane interpolymer comprising at least one Si—H group, b) at least one peroxide, and c) at least one crosslinking coagent, wherein the composition has a mole ratio of active oxygen atom to carbon-carbon double bond of ≥0.02 and ≤0.7, based on the active oxygen atom content of component b and the carbon-carbon double bond content of component c.

### BACKGROUND OF THE INVENTION

Peroxide-initiated crosslinking, functionalization and rheology modification of polyolefin elastomers (POE) are widely used in olefin-based polymer applications. The reaction characteristics (efficiency, curing speed, and reaction selectivity) are crucial factors that can largely affect polymer formulation, part processing and part performance. For example, an olefin-based polymer with an improved rate and effectiveness of crosslinking can help customers reduce the cycle time of part manufacturing and/or minimize the usage of costly curing additives in the formulation. There is a need for olefin-based polymer compositions that can be crosslinked at improved (faster) crosslinking rates and improved crosslinking efficiencies (higher degrees of crosslinking). However, with peroxide-initiated crosslinking, various by-products are formed by peroxides during their thermal decomposition. Such by-products in the crosslinked parts can lead to undesired characteristics, such as unpleasant or unhealthy odors and poor electrical properties.

Crosslinking coagents are usually combined with peroxide for crosslinking (curing). When a certain level of coagent is used, the peroxide loading can be reduced to some extent. With the replacement of parts of peroxide with a certain amount of coagent, the undesired characteristics noted above can be mitigated, as the coagent can boost curing without forming by-products. However, for conventional POE, the ratio of peroxide to coagent can be only modulated within a narrow range without sacrificing curing level. When the combination of too little peroxide and too much coagent (too low of ratio of peroxide to coagent) is used, a desired high curing level cannot be achieved. There is a need for a solution to further reduce peroxide loading level while still achieving a high curing level. This need has been met by the following invention.

### SUMMARY OF THE INVENTION

A process to form a crosslinked composition, the process comprising thermally treating a composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

A composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

### DETAILED DESCRIPTION OF THE INVENTION

Compositions containing olefin/silane interpolymers have been discovered that provide the following distinctive features and related benefits: a) improved curing effectiveness under low peroxide loading, which allows for a reduction in peroxide loading for cost saving and reduced peroxide side-reactions and by-products; b) improved curing rate, which allows for a reduction in cycle time, an increase in the throughput of manufactured parts, and a reduction in the variable cost in equipment; c) selective formation of chemical bonding with the -silicon hydride (Si—H) functional groups, which allows for the design of distinctive polymer network microstructures with tailored properties. In this invention, it was unexpectedly found that the present compositions can enable a much lower ratio of peroxide to coagent (or a much higher ratio of coagent to peroxide) for reaching a certain high curing level compared to compositions based on conventional POE.

Processes to effectively cure these compositions have also been discovered. Also, it has been discovered that the silicon hydride functional groups can readily react with peroxide, to form a sufficiently crosslinked interpolymer, without the need for an additional cure catalyst. It has also been discovered that even a small fraction (for example, ≤5.0 wt %) of the incorporated silane comonomer greatly improves the crosslinking effectiveness of the composition, as compared to the crosslinking of ethylene-based polymers using conventional crosslinking methods.

As discussed, in a first aspect, a process to form a crosslinked composition is provided, which comprises thermally treating a composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

The above process may comprise a combination of two or more embodiments, as described herein. Each component a, b and c may comprise a combination of two or more embodiments, as described herein.

Also provided, in a second aspect, is a composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

The above composition may comprise a combination of two or more embodiments, as described herein. Each component a, b and c may comprise a combination of two or more embodiments, as described herein.

The following embodiments apply to both the first aspect and the second aspect of the invention, unless stated otherwise.

In one embodiment, or a combination of two or more embodiments, each described herein, the olefin/silane interpolymer of component a is an ethylene/silane copolymer, an ethylene/alpha-olefin/silane interpolymer, or an ethylene/alpha-olefin/silane terpolymer. In one embodiment, or a combination of two or more embodiments, each described herein, the olefin/silane interpolymer of component a is an olefin/silane interpolymer formed in the presence of a bis-biphenyl-phenoxy metal complex

In one embodiment, or a combination of two or more embodiments, each described herein, the composition comprises only one olefin/silane interpolymer for component a, or only one ethylene/alpha-olefin/silane interpolymer, or only one ethylene/alpha-olefin/silane terpolymer. In one embodiment, or a combination of two or more embodiments, each described herein, the composition comprises two or more olefin/silane interpolymers for component a, or two or more ethylene/alpha-olefin/silane interpolymers, or two or more ethylene/alpha-olefin/silane terpolymers.

In one embodiment, or a combination of two or more embodiments, each described herein, the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt %, or ≥1.5 wt % of the silane, based on the weight of the interpolymer. In one embodiment, or a combination of two or more embodiments, each described herein, the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer. In one embodiment, or a combination of two or more embodiments, each described herein, the interpolymer of component a comprises, in polymerized form, ≤5.0 wt %, or ≤4.5 wt %, or ≤4.0 wt %, or ≤3.0 wt %, or ≤2.0 wt %, or ≤1.5 wt % of the silane, based on the weight of the interpolymer.

In one embodiment, or a combination of two or more embodiments, each described herein, the interpolymer of component a has a molecular weight distribution (MWD=Mw/Mn)≥1.5, or ≥1.6, or ≥1.7, or ≥1.8, or ≥1.9. In one embodiment, or a combination of two or more embodiments, each described herein, the interpolymer of component a has a molecular weight distribution MWD≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.

In one embodiment, or a combination of two or more embodiments, each described herein, the silane is derived from a silane monomer selected from Formula 1:

A-(SiBC—O)ₓ—Si-EFH (Formula 1),
where A is an alkenyl group, B is a hydrocarbyl group or hydrogen, C is a hydrocarbyl group or hydrogen, and where B and C may be the same or different;
H is hydrogen, and x≥0;
E is a hydrocarbyl group or hydrogen, F is a hydrocarbyl group or hydrogen, and where E and F may be the same or different.

In one embodiment, or a combination of two or more embodiments, each described herein, Formula 1 is selected from the following compounds s1) through s16) below:

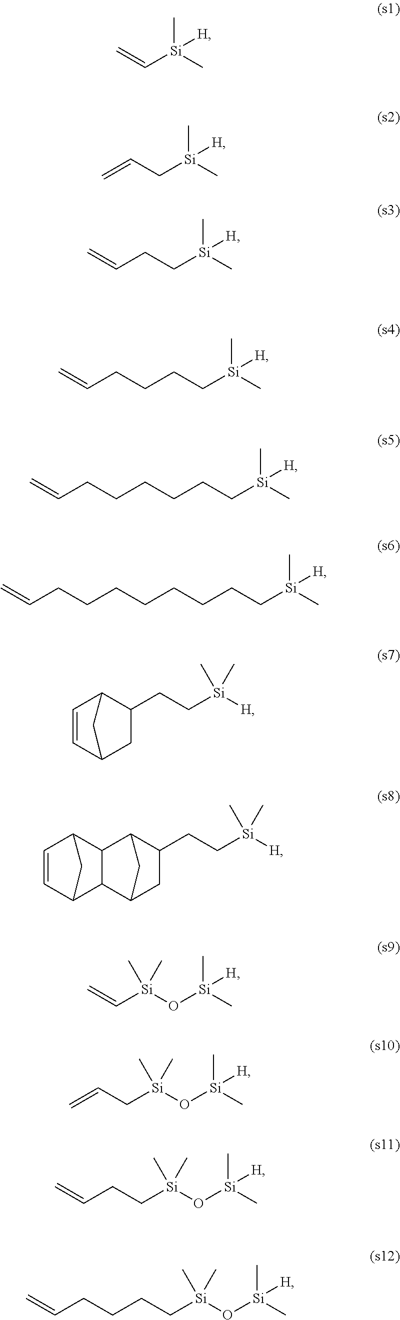

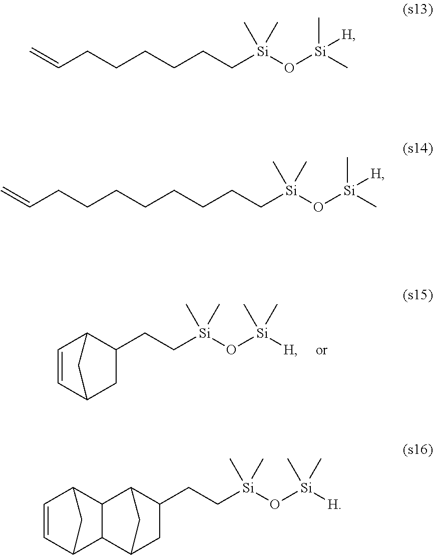

In one embodiment, or a combination of two or more embodiments, each described herein, the composition has a mole ratio of active oxygen atom to carbon-carbon double bond of ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7, based on the active oxygen atom content of component b and the carbon-carbon double bond content of component c. In one embodiment, or a combination of two or more embodiments, each described herein, the composition has a mole ratio of active oxygen atom to carbon-carbon double bond of ≤0.7, or ≤0.6, or ≤0.5, based on the active oxygen atom content of component b and the carbon-carbon double bond content of component c.

In one embodiment, or a combination of two or more embodiments, each described herein, the composition has a weight ratio of component c to component b of at least 0.7, or at least 1.0, or at least 1.4, or at least 2.0, or at least 3.0, or at least 4.0, or at least 5.0, or at least 6.0, or at least 7.0, or at least 8.0, or at least 9.0, or at least 10.0, or at least 11.0, or at least 12.0, or at least 15.0, or at least 20.0, or at least 25.0, or at least 30.0, or at least 35.0, or at least 40.0, or at least 45.0, or at least 50.0, or at least 55.0, or at least 60.0, or at least 65.0, or at least 70.0.

In one embodiment, or a combination of two or more embodiments, each described herein, the composition has a weight ratio of component c to component b of ≥0.7, or ≥1.0, or ≥1.4, or ≥2.0, or ≥3.0, or ≥4.0, or ≥5.0, or ≥6.0, or ≥7.0, or ≥8.0, or ≥9.0, or ≥10.0, or ≥11.0, or ≥12.0, or ≥15.0, or ≥20.0, or ≥25.0, or ≥30.0, or ≥35.0, or ≥40.0, or ≥45.0, or ≥50.0, or ≥55.0, or ≥60.0, or ≥65.0, or ≥70.0. In one embodiment, or a combination of two or more embodiments, each described herein, the composition has a weight ratio of component c to component b of ≤100.0, or ≤90.0, or ≤80.0, or ≤70.0, or ≤65.0.

In one embodiment, or a combination of two or more embodiments, each described herein, the composition has a mole ratio of “the active oxygen atom in component b” to component c of ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7. In one embodiment, or a combination of two or more embodiments, each described herein, the composition has a mole ratio of “the active oxygen atom in component b” to component c of ≤0.7, or ≤0.6, or ≤0.5.

In one embodiment, or a combination of two or more embodiments, each described herein, the composition further comprises an ethylene/alpha-olefin interpolymer, or an ethylene/alpha-olefin copolymer. In one embodiment, or a combination of two or more embodiments, each described herein, the composition comprises only one peroxide for component b. In one embodiment, or a combination of two or more embodiments, each described herein, the composition comprises two or more peroxides for component b. In one embodiment, or a combination of two or more embodiments, each described herein, the composition comprises two or more crosslinking coagents for component c.

In one embodiment, or a combination of two or more embodiments, each described herein, the composition is thermally treated at a temperature ≥120° C., or ≥130° C., or ≥140° C., or ≥150° C. In one embodiment, or a combination of two or more embodiments, each described herein the composition is thermally treated at a temperature ≤200° C., or ≤195° C., or ≤190° C., or ≤185° C., or ≤180° C.

Also is provided a crosslinked composition formed by an inventive process as described herein, or from an inventive composition as described herein.

Also provided is an article comprising at least one component formed from a composition of any one embodiment, or a combination of two or more embodiments, each described herein. In one embodiment, or a combination of two or more embodiments, each described herein, the article is a film. In one embodiment, or a combination of two or more embodiments, each described herein, the article is a solar cell module, an encapsulant film, a cable, a footwear component, an automotive part, a window profile, a tire, a tube/hose, or a roofing membrane.

### Silane Monomer

A silane monomer, as used herein, comprises at least one (type) Si—H group. In one embodiment, the silane monomer is selected from Formula 1, as discussed above.

Some examples of silane monomers include hexenylsilane, allylsilane, vinylsilane, octenylsilane, hexenyldimethylsilane, octenyldimethylsilane, vinyldimethylsilane, vinyldiethylsilane, vinyldi(n-butyl)silane, vinylmethyloctadecylsilane, vinyidiphenylsilane, vinyldibenzylsilane, allyldimethylsilane, allyldiethylsilane, allyldi(n-butyl)silane, allylmethyloctadecylsilane, allyldiphenylsilane, bishexenylsilane, and allyidibenzylsilane. Mixtures of the foregoing alkenylsilanes may also be used.

More specific examples of silane monomers include the following: (5-hexenyl-dimethylsilane (HDMS), 7-octenyldimethylsilane (ODMS), allyldimethylsilane (ADMS), 3-butenyldimethylsilane, 1-(but-3-en-1-yl)-1,1,3,3-tetramethyldisiloxane (BuMMH), 1-(hex-5-en-1-yl)-1,1,3,3-tetramethyldisiloxane (HexMMH), (2-bicyclo[2.2.1]hept-5-en-2-yl)ethyl)-dimethylsilane (NorDMS) and 1-(2-bicyclo[2.2.1]hept-5-en-2-yl)ethyl)-1,1,3,3-tetramethyldisiloxane (NorMMH). Mixtures of the foregoing alkenylsilanes may also be used.

### Peroxide

As noted above, the composition comprises a peroxide. As used herein, a peroxide contains at least one oxygen-oxygen bond (O—O). Peroxides include, but are not limited to, dialkyl, diaryl, dialkaryl, and diaralkyl peroxide, having the same or differing respective alkyl, aryl, alkaryl, and aralkyl moieties, and further each dialkyl, diaryl, dialkaryl, and diaralkyl peroxide, having the same respective alkyl, aryl, alkaryl, and aralkyl moieties.

Exemplary organic peroxides include dicumyl peroxide (“DCP”); tert-butyl peroxybenzoate; di-tert-amyl peroxide (“DTAP”); bis(t-butyl-peroxy isopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy) 3,3,5-trimethylcyclohexane; isopropylcumyl cumylperoxide; butyl 4,4-di(tert-butylperoxy)valerate; di(isopropylcumyl) peroxide; 1,1-di-(tert-butylperoxy)cyclohexane (“Luperox 331”); 1,1-di-(tert-amylperoxy)cyclohexane (“Luperox 531”); tert-butylperoxyacetate (“TBPA”); tert-amyl peroxyacetate (“TAPA”); 2,5-dimethyl-2,5-di(tert-butylperoxy)hexane (“Luperox 101”); tert-Butylperoxy-2-ethylhexyl carbonate (“TBEC”); and mixtures of two or more thereof.

In one or more embodiments, the peroxide may be a cyclic peroxide. An example of a cyclic peroxide is represented by the following Formula 2:

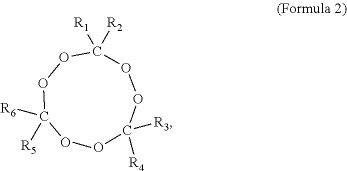

wherein R1-R6 are each independently hydrogen or an inertly-substituted or unsubstituted C1-C20 alkyl, C3-C20 cycloalkyl, C6-C20 aryl, C7-C20 aralkyl, or C7-C20 alkaryl. Representative of the inert-substituents included in R1-R6 are hydroxyl, C1-C20 alkoxy, linear or branched C1-C20 alkyl, C6-C20 aryloxy, halogen, ester, carboxyl, nitrile, and amido. In one or more embodiments, R1-R6 are each independently lower alkyls, including, for example, a C1-C10 alkyl, or a C1-C4 alkyl.

A number of cyclic peroxides are commercially available, for example, under the tradename TRIGONOX, such as 3,6,9-triethyl-3,6,9-trimethyl-1,4,7-triperoxonane. Examples of cyclic peroxides include those derived from acetone, methylamyl ketone, methylheptyl ketone, methylhexyl ketone, methylpropyl ketone, methylbutyl ketone, diethyl ketone, methylethyl ketone, methyloctyl ketone, methylnonyl ketone, methyldecyl ketone, methylundecyl ketone and combinations thereof, among others. The cyclic peroxides can be used alone or in combination with one another. The peroxide can be liquid, solid, or paste.

### Crosslinking Coagent

As used herein, a “crosslinking coagent” is a compound that promotes crosslinking; for example, by helping to establish a higher concentration of reactive sites and/or helping to reduce the chance of deleterious radical side reactions. Crosslinking coagents include, but are not limited to, triallyl cyanurate (TAC), triallyl phosphate (TAP), triallyl isocyanurate (TAIC), 1,3,5,7-tetravinyl-1,3,5,7-tetramethylcyclotetrasiloxane (Vinyl D4), 2,4,6-trimethyl-2,4,6-trivinyl-1,3,5,2,4,6-trioxatrisilinane (Vinyl D3), 2,4,6,8,10-pentamethyl-2,4,6,8,10-pentavinyl-1,3,5,7,9,2,4,6,8,10-pentaoxapentasilecane (Vinyl D5), dipentaerythritolpenta-acrylate and trimethylolpropane triacrylate, triallyl trimellitate; N,N,N′,N′,N″,N″-hexaallyl-1,3,5-triazine-2,4,6-triamine; triallyl orthoformate; pentaerythritol triallyl ether; triallyl citrate; triallyl aconitate; trimethylolpropane triacrylate; trimethylolpropane trimethylacrylate; ethoxylated bisphenol A dimethacrylate; 1,6-hexanediol diacrylate; pentaerythritol tetraacrylate; dipentaerythritol pentaacrylate; tris(2-hydroxyethyl) isocyanurate triacrylate; propoxylated glyceryl triacrylate; a polybutadiene having at least 50 wt % 1,2-vinyl content; trivinyl cyclohexane; certain dicarbonyl species, e.g., 1,3-diacetylbenzene (DAB); and mixtures of any two or more thereof.

### Additives

An inventive composition may comprise one or more additives. Additives include, but are not limited to, UV stabilizer, antioxidants, fillers, scorch retardants, tackifiers, waxes, compatibilizers, adhesion promoters, plasticizers (for example, oils), blocking agents, antiblocking agents, anti-static agents, release agents, anti-cling additives, colorants, dyes, pigments, and combination thereof.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, at least 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, at least 50 wt % or a majority weight percent of propylene (based on the weight of the polymer), and optionally may comprise one or more comonomers.

The term “ethylene-based polymer,” as used herein, refers to a polymer that comprises, in polymerized form, at least 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, at least 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, at least 50 wt % or a majority weight percent of ethylene (based on the weight of the copolymer), and an alpha-olefin, as the only two monomer types.

The term “olefin/silane interpolymer,” as used herein, refers to a random interpolymer that comprises, in polymerized form, at least 50 wt % or a majority weight percent of an olefin (based on the weight of the interpolymer), and a silane monomer. As used herein, the interpolymer comprises at least one Si—H group, and the phrase “at least one Si—H group” refers to a type of “Si—H” group. It is understood in the art that the interpolymer would contain a multiple number of these groups. The olefin/silane interpolymer is formed by the copolymerization (for example, using a bis-biphenyl-phenoxy metal complex) of at least the olefin and the silane monomer. An example of a silane monomer is depicted in Formula 1, as described above.

The term “ethylene/silane interpolymer,” as used herein, refers to a random interpolymer that comprises, in polymerized form, at least 50 wt % or a majority weight percent of ethylene (based on the weight of the interpolymer), and a silane monomer. As used herein, the interpolymer comprises at least one Si—H group, and the phrase “at least one Si—H group,” as discussed above. The ethylene/silane interpolymer is formed by the copolymerization of at least the ethylene and the silane monomer.

The term “ethylene/alpha-olefin/silane interpolymer,” as used herein, refers to a random interpolymer that comprises, in polymerized form, at least 50 wt % or a majority weight percent of ethylene (based on the weight of the interpolymer), an alpha-olefin and a silane monomer. As used herein, these interpolymer comprises at least one Si—H group, as discussed above. The ethylene/silane interpolymer is formed by the copolymerization of at least the ethylene, the alpha-olefin and the silane monomer.

The term “ethylene/alpha-olefin/silane terpolymer,” as used herein, refers to a random terpolymer that comprises, in polymerized form, at least 50 wt % or a majority weight percent of ethylene (based on the weight of the terpolymer), an alpha-olefin and a silane monomer as the only three monomer types. As used herein, the terpolymer comprises at least one Si—H group, as discussed above. The ethylene/silane terpolymer is formed by the copolymerization of the ethylene, the alpha-olefin and the silane monomer.

The phrase “a majority weight percent,” as used herein, in reference to a polymer (or interpolymer, or terpolymer or copolymer), refers to the amount of monomer present in the greatest amount in the polymer.

The terms “hydrocarbon group,” “hydrocarbyl group,” and similar terms, as used herein, refer to a chemical group containing only carbon and hydrogen atoms.

The term “crosslinked composition,” as used herein, refers to a composition that has a network structure due to the formation of chemical bonds between polymer chains. The degree of formation of this network structure is indicated by the increase in the “MH-ML” value as discussed herein.

The terms “thermally treating,” “thermal treatment,” and similar terms, as used herein, in reference to a composition comprising an olefin/silane interpolymer, refer to the application of heat to the composition. Heat may be applied by electrical means (for example, a heating coil) and/or by radiation and/or by hot oil and/or by mechanical shearing. Note, the temperature at which the thermal treatment takes place, refers to the temperature of the composition (for example, the melt temperature of the composition).

The term “bis-biphenyl-phenoxy metal complex,” as used herein, refers to complexes such as those disclosed in WO2012/027448. Examples of such complexes include but are not limited to “PE CAT 1” and “PE CAT 2” as seen below in the experimental section. Specifically, the term “bis-biphenyl-phenoxy metal complex,” as used herein, refers to a chemical structure comprising a metal or metal ion that is bonded and/or coordinated to one or more, and preferably two, biphenyl-phenoxy ligands. In one embodiment, the chemical structure comprises a metal that is bonded to two, biphenyl-phenoxy ligands, via an oxygen atom of each respective biphenyl-phenoxy ligand. The metal complex is typically rendered catalytically active by the use of one or more cocatalysts.

For example, see Formula DI below:

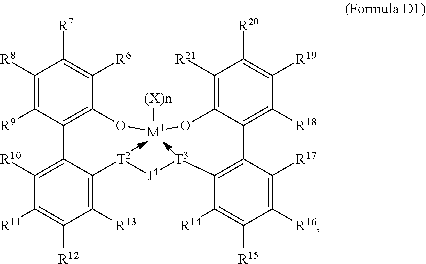

wherein M1 is a metal selected from zirconium (Zr) or hafnium (Hf) or titanium (Ti), and further Zr of Hf; and wherein the metal is in a formal oxidation state of +2, +3, or +4;
each X is independently selected from a substituted or unsubstituted (C1-C30) hydro-carbyl, a substituted or unsubstituted (C1-C30) heterohydrocarbyl, and —H; and wherein each X is independently a monodentate ligand or a bidentate ligand;
n is 0, 1, or 2, and optionally when n is 1, X may be a bidentate ligand;
each of -T2- and -T3- is independently selected from —O—, —S—, —N(RN)—, and —P(RP)—;
R6 and R21 are each independently selected from the group consisting of —H, a substituted or unsubstituted (C1-C40) hydrocarbyl, a substituted or unsubstituted (C1-C40) heterohydrocarbyl, —Si(RC)₃, —Ge(RC)₃, —P(RP)₂, —N(RN)₂, —ORC, —SRC, —NO₂, —CN, —CF₃, RCS(O)—, RCS(O)₂—, (RC)₂C═N—, RCC(O)O—, RCOC(O)—, RCC(O)N(R)—, (RC)₂NC(O)—, halogen, radicals having formula (I), radicals having formula (II), and radicals having formula (III):

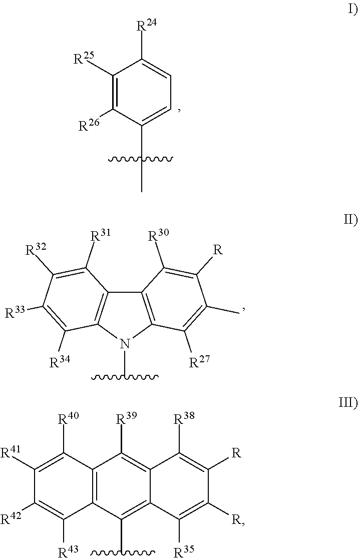

where each of R22-26, R27-34, and R35-43 is independently selected from a substituted or unsubstituted (C1-C40) hydrocarbyl, a substituted or unsubstituted (C1C40) hetero-hydrocarbyl, —Si(RC)₃, —Ge(RC)₃, —P(RP)₂, —N(RN)₂, —N═CHRC, —ORC, —SRC, —NO₂, —CN, —CF₃, RCS(O)—, RCS(O)₂—, (RC)₂C═N—, RCC(O)O—, RCOC(O)—, RCC(O)N(RN)—, (RC)₂NC(O)—, halogen, and —H;
each of R7-R20 is independently selected from a substituted or unsubstituted (C1-C40) hydrocarbyl, a substituted or unsubstituted (C1-C40) heterohydrocarbyl, —Si(RC)₃, —Ge(RC)₃, —P(RP)₂, —N(RN)₂, —N═CHRC, —ORC, —SRC, —NO₂, CN, CF₃, RCS(O)—, RCS(O)₂—, (RC)₂C═N—, RCC(O)O—, RCOC(O)—, RCC(O)N(RN)—, (RC)₂NC(O)—, halogen, and —H;
J4 is a substituted or unsubstituted (C1-C40) hydrocarbylene or a substituted or unsubstituted (C1-C40) heterohydrocarbylene, wherein the substituted or unsubstituted (C1-C40) hydrocarbylene has a portion that comprises a 1-carbon atom to 10-carbon atom linker backbone, linking the groups T2 and T3 in Formula D1 (to which J4 is bonded); or the substituted or unsubstituted (C1-C40) heterohydrocarbylene has a portion that comprises a 1-atom to 10-atom linker backbone, linking the groups T2 and T3 in Formula D1, wherein each of the 1 to 10 atoms of the 1-atom to 10-atom linker backbone, independently, is a carbon atom or heteroatom of a heteroatom group, wherein each heteroatom group is independently O, S, S(O), S(O)₂, Si(RC)₂, Ge(RC)₂, P(RC), or N(RC), wherein each RC is independently a substituted or unsubstituted (C1-C30) hydrocarbyl or a substituted or unsubstituted (C1-C30) heterohydrocarbyl; and
wherein each RP, RN, and remaining RC in Formula DI is independently a substituted or unsubstituted (C1-C30) hydrocarbyl, a substituted or unsubstituted (C1-C30)-heterohydro-carbyl, or —H; and wherein the metal complex is overall charge-neutral.

With respect to the term “ratio,” as used herein, a value of X is understood to be X: 1 (or X to 1). For example, a ratio of at least 2.0 is understood to be 2.0:1.0 (or 2.0 to 1.0).

The term “alkenyl group,” as used herein, refers to an organic chemical group that contains at least one carbon-carbon double bond (C═C). In a preferred embodiment, the alkenyl group is an example of a hydrocarbon group containing at least one carbon-carbon double bond, or containing only one carbon-carbon double bond.

The term “active oxygen atom,” as used herein, refers to the oxygen atoms present as one of two covalently bonded oxygen atoms in the organic peroxide. For example, a mono-functional peroxide has two active oxygen atoms. Oxygen atoms present in the organic peroxide that are not covalently bonded to another oxygen atom are not considered active oxygen atoms. As used herein, “mono-functional peroxides” denote peroxides having a single pair of covalently bonded oxygen atoms (e.g., having a structure R—O—O—R). A mono-functional peroxide has two active oxygen atoms. As used herein, “di-functional peroxides” denote peroxides having two pairs of covalently bonded oxygen atoms (e.g., having a structure R—O—O—R—O—O—R). In an embodiment, the organic peroxide is a mono-functional peroxide.

The “active oxygen atom content of component b” refers to the total moles of active oxygen atoms in component b. The “carbon-carbon double bond content of component c” refers to the total moles of carbon-carbon double bonds in component c. The follow equation is the calculation of the mole ratio of active oxygen atom to carbon-carbon double bond, based on the active oxygen atom content of component b and the carbon-carbon double bond content of component c, when the composition comprises only one peroxide for component b and only one crosslinking coagent for component c. When the composition comprises more than one peroxide for component b and/or more than one crosslinking coagent for component c, the same calculation is performed, except the numerator will be the total for all peroxides and the denominator will be the total for all coagents.

$$\frac{( Moles of peroxide ) ( Number of active oxygen atoms per peroxide molecule )}{( Moles of coagent ) ( Number of carbon - carbon double bonds per coagent molecue )}$$

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation, any other component, step or procedure, excepting those that are not essential to operability. The term “consisting of” excludes any component, step or procedure, not specifically delineated or listed.

### Listing of Some Processes and Compositions

A] A process to form a crosslinked composition, the process comprising thermally treating a composition that comprises the following components:
a) at least one olefin/silane interpolymer comprising at least one (type) Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.
   B] The process of A] above, wherein the olefin/silane interpolymer of component a is an ethylene/alpha-olefin/silane interpolymer, or an ethylene/alpha-olefin/silane terpolymer.
   C] The process of B] above, wherein the alpha-olefin of the ethylene/alpha-olefin/silane interpolymer, or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
   D] The process of any one of A]-C] (A] through C]) above, wherein the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt %, or ≥1.5 wt % of the silane, based on the weight of the interpolymer.
   E] The process of any one of A]-D] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer.
   F] The process of any one of A]-E] above, wherein the interpolymer of component a comprises, in polymerized form, ≤5.0 wt %, or ≤4.5 wt %, or ≤4.0 wt %, or ≤3.0 wt %, or ≤2.0 wt %, or ≤1.5 wt % of the silane, based on the weight of the interpolymer.
   G] The process of any one of A]-F] above, wherein the interpolymer of component a has a molecular weight distribution (MWD=Mw/Mn)≥1.5, or ≥1.6, or ≥1.7, or ≥1.8, or ≥1.9.
   H] The process of any one of A]-G] above, wherein the interpolymer of component a has a molecular weight distribution MWD≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.
   I] The process of any one of A]-H] above, wherein the interpolymer of component a has a number average molecular weight (Mn)≥10,000 g/mol, or ≥12,000 g/mol, or ≥14,000 g/mol, or ≥16,000 g/mol, or ≥18,000 g/mol, or ≥20,000 g/mol, or ≥22,000 g/mol, or ≥24,000 g/mol, or ≥26,000 g/mol, or ≥28,000 g/mol, or ≥30,000 g/mol, or ≥32,000 g/mol.
   J] The process of any one of A]-I] above, wherein the interpolymer of component a has a number average molecular weight (Mn)≤100,000 g/mol, or ≤95,000 g/mol, or ≤90,000 g/mol, or ≤85,000 g/mol, or ≤80,000 g/mol, or ≤75,000 g/mol, or ≤70,000 g/mol, or ≤68,000 g/mol, or ≤66,000 g/mol, or ≤64,000 g/mol, or ≤62,000 g/mol, or ≤60,000 g/mol.
   K] The process of any one of A]-J] above, wherein the interpolymer of component a has a weight average molecular weight (Mw)≥20,000 g/mol, or ≥25,000 g/mol, or ≥30,000 g/mol, or ≥35,000 g/mol, or ≥40,000 g/mol, or ≥45,000 g/mol, or ≥50,000 g/mol, or ≥52,000 g/mol, or ≥54,000 g/mol, or ≥56,000 g/mol, or ≥58,000 g/mol, or ≥60,000 g/mol, or ≥62,000 g/mol.
   L] The process of any one of A]-K] above, wherein the interpolymer of component a has a weight average molecular weight (Mw)≤300,000 g/mol, or ≤250,000 g/mol, or ≤200,000 g/mol, or ≤190,000 g/mol, or ≤180,000 g/mol, or ≤170,000 g/mol, or ≤160,000 g/mol, or ≤150,000 g/mol, or ≤148,000 g/mol, or ≤146,000 g/mol, or ≤144,000 g/mol, or ≤142,000 g/mol, or ≤140,000 g/mol, or ≤138,000 g/mol.
   M] The process of any one of A]-L] above, wherein the interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.870 g/cc, or ≥0.874 g/cc, or ≥0.876 g/cc, or ≥0.878 g/cc (1 cc=1 cm³).
   N] The process of any one of A]-M] above, wherein the interpolymer of component a has a density ≤0.950 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc.
   O] The process of any one of A]-N] above, wherein the interpolymer of component a has a melt index (12)≥0.5 dg/min, or ≥1.0 dg/min, or ≥2.0 dg/min, or ≥5.0 dg/min, or ≥10 dg/min, or ≥15 dg/min.
   P] The process of any one of A]-O] above, wherein the interpolymer of component a has a melt index (12)≤1,000 dg/min, or ≤500 dg/min, or ≤250 dg/min, or ≤100 dg/min, or ≤50 dg/min, or ≤20 dg/min.
   Q] The process of any one of A]-P] above, wherein the interpolymer of component a has an I10/I2 ratio ≥6.0, or ≥7.0, or ≥8.0, or ≥9.0, or ≥10.
   R] The process of any one of A]-Q] above, wherein the interpolymer of component a has an I10/I2 ratio≤30, or ≤25, or ≤20, or ≤15, or ≤12.
   S] The process of any one of A]-R] above, wherein the silane is derived from a silane monomer selected from Formula 1, as described above.
   T] The process of S] above, wherein, for Formula 1, x is from 0 to 10, or from 0 to 8, or from 0 to 6, or from 0 to 4, or from 0 to 2, or 0 or 1, or 0.
   U] The process of S] or T] above, wherein, for Formula 1, A is a C2-C50 alkenyl group, or a C2-C40 alkenyl group, or a C2-C30 alkenyl group, or a C2-C20 alkenyl group.
   V] The process of any one of S]-U] above, wherein, for Formula 1, A is selected from the following structures i)-iv):
i) R¹R²C═CR³—, where each of R¹, R² is independently hydrogen or an alkyl group, and R³ is hydrogen, and wherein R¹ and R² may be the same or different;
ii) R¹R²C═CR³—(CR⁴R⁵)ₙ—, where each of R¹, R², R⁴, R⁵ is independently hydrogen, or an alkyl group, and R³ is hydrogen, and wherein two or more from R¹, R², R⁴, R⁵ may be the same or different, and n is from 1 to 10, or 1 to 8, or 1 to 6, or 1 to 4, or 1 to 2, or 1;
iii)

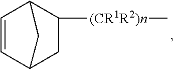

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1; or
iv)

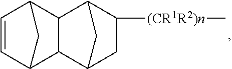

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1.
W] The process of any one of S]-V] above, wherein, for Formula 1, A is selected from the following structures i)-iv):
i) H₂C═CH—;
ii) H₂C═CH—(CH₂)ₙ—, where n is from 1 to 10, or 1 to 8, or 1 to 6, or 1 to 4, or 1 to 2, or 1;
iii)

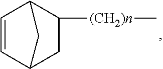

where n is from 1 to 10, or 1 to 8, or 1 to 6, or 1 to 4, or 1 to 2, or 1; or
iv)

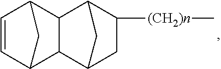

where n is from 1 to 10, or 1 to 8, or 1 to 6, or 1 to 4, or 1 to 2, or 1.
X] The process of any one of S]-W] above, wherein, for Formula 1, B is an alkyl, or a C1-C5 alkyl, or a C1-C4 alkyl, or a C1-C3 alkyl, or a C1-C2 alkyl, or methyl.
Y] The process of any one of S]-X] above, wherein, for Formula 1, C is an alkyl, or a C1-C5 alkyl, or a C1-C4 alkyl, or a C1-C3 alkyl, or a C1-C2 alkyl, or methyl.
Z] The process of any one of S]-Y] above, wherein, for Formula 1, E is an alkyl, or a C1-C5 alkyl, or a C1-C4 alkyl, or a C1-C3 alkyl, or a C1-C2 alkyl, or methyl.
A2] The process of any one of S]-Z] above, wherein, for Formula 1, F is an alkyl, or a C1-C5 alkyl, or a C1-C4 alkyl, or a C1-C3 alkyl, or a C1-C2 alkyl, or methyl.
B2] The process of any one of S]-A2] above, wherein Formula 1 is selected from compounds s1) through s16), as described above.
C2] The process of any one of S]-B2] above, wherein Formula 1 is selected from structures s1) to s8), as described above.
D2] The process of any one of S]-B2] above, wherein Formula 1 is selected from structures s9) to s16), as described above.
E2] The process of any one of A]-D2] above, wherein the silane is derived from a silane monomer selected from the following compounds: (5-hexenyl-dimethylsilane (HDMS), 7-octenyldimethylsilane (ODMS), allyldimethylsilane, 3-butenyldimethyl-silane, 1-(but-3-en-1-yl)-1,1,3,3-tetramethyl-disiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethyl-silane (NorDMS), 1-(2-bicyclo[2.2.1]hept-5-en-2-yl)ethyl)-1,1,3,3-tetramethyldisiloxane (NorMMH), and any combination thereof.
F2] The process of any one of A]-E2] above, wherein the composition has a weight ratio of component a to component b ≥100, or ≥200, or ≥300, or ≥400, or ≥500, or ≥600, or ≥700, or ≥800, or ≥900, or ≥1000, or ≥1100, or ≥1200, or ≥1300, or ≥1400, or ≥1500, or ≥1600, or ≥1700, or ≥1800, or ≥1900, or ≥2000.
G2] The process of any one of A]-F2] above, wherein the composition has a weight ratio of component a to component b ≤3000, or ≤2500, or ≤2000.
H2] The process of any one of A]-G2] above, wherein the composition has a mole ratio of active oxygen atom to carbon-carbon double bond of ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7, based on the active oxygen atom content of component b and the carbon-carbon double bond content of component c.
I2] The process of H2] above, wherein the composition has a mole ratio of active oxygen atom to carbon-carbon double bond of ≤0.7, or ≤0.6, or ≤0.5, based on the active oxygen atom content of component b and the carbon-carbon double bond content of component c.

J2] The process of H2] or I2] above, wherein the composition has a weight ratio of component c to component b of ≥0.7, or ≥1.0, or ≥1.4, or ≥2.0, or ≥3.0, or ≥4.0, or ≥5.0, or ≥6.0, or ≥7.0, or ≥8.0, or ≥9.0, or ≥10.0, or ≥11.0, or ≥12.0, or ≥15.0, or ≥20.0, or ≥25.0, or ≥30.0, or ≥35.0, or ≥40.0, or ≥45.0, or ≥50.0, or ≥55.0, or ≥60.0, or ≥65.0, or ≥70.0.

K2] The process of any one of A]-J2] above, wherein the composition has a weight ratio of component c to component b of ≤100.0, or ≤90.0, or ≤80.0, or ≤70.0, or ≤65.0.
L2] The process of any one of A]-K2] above, wherein the composition has a mole ratio of “the active oxygen atom in component b” to component c ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7.
M2] The process of any one of H2]-L2] above, wherein the composition has a mole ratio of “the active oxygen atom in component b” to component c ≤0.7, or ≤0.6, or ≤0.5.
N2] The process of any one of H2]-M2] above, wherein the olefin/silane interpolymer of component a is an olefin/silane interpolymer formed in the presence of a bis-biphenyl-phenoxy metal complex.
O2] The process of any one of A]-N2] above, wherein the composition comprises ≥20.0 wt %, or ≥30.0 wt %, or ≥40.0 wt %, or ≥45.0 wt %, or ≥50.0 wt %, or ≥55.0 wt %, or ≥60.0 wt %, or ≥65.0 wt %, or ≥70.0 wt %, or ≥75.0 wt %, or ≥80.0 wt %, or ≥85.0 wt %, or ≥90.0 wt %, or ≥95.0 wt %, or ≥96.0 wt %, or ≥97.0 wt %, or ≥98.0 wt %, or ≥99.0 wt % of component a, based on the weight of the composition.
P2] The process of any one of A]-O2] above, wherein the composition comprises ≤99.9 wt %, or ≤99.8 wt %, or ≤99.6 wt %, or ≤99.4 wt %, or ≤99.2 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of component a, based on the weight of the composition.
Q2] The process of any one of A]-P2] above, wherein the composition comprises ≥0.01 wt %, or ≥0.05 wt %, or ≥0.10 wt %, or ≥0.15 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt % of component b, based on the weight of the composition.
R2] The process of any one of A]-Q2] above, wherein the composition comprises ≤5.0 wt %, or ≤4.0 wt %, or ≤3.0 wt %, or ≤2.0 wt %, or ≤1.50 wt %, or ≤1.0 wt % of component b, based on the weight of the composition.
S2] The process of any one of A]-R2] above, wherein the composition comprises ≥0.1 wt %, or ≥0.5 wt %, or ≥0.9 wt %, or ≥1.00 wt %, or ≥1.50 wt %, or ≥1.70 wt %, or ≥1.90 wt %, or ≥2.0 wt %, or ≥2.50 wt %, or ≥3.0 wt %, or ≥3.14 wt %, or ≥3.15 wt %, or ≥3.20 wt % of component c, based on the weight of the composition.
T2] The process of any one of A]-S2] above, wherein the composition comprises ≤5.0 wt %, or ≤4.0 wt %, or ≤3.50 wt %, or ≤3.20 wt %, or ≤3.14 wt % of component c, based on the weight of the composition.
U2] The process of any one of A]-T2] above, wherein the composition comprises ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥97.0 wt %, or ≥98.0 wt %, or ≥98.2 wt %, or ≥98.4 wt %, or ≥98.6 wt %, or ≥98.8 wt %, or ≥99.0 wt % the sum of components a and b, based on the weight of the composition.
V2] The process of any one of A]-U2] above, wherein the composition comprises ≤100.0 wt %, or ≤99.0 wt %, or ≤99.8 wt %, or ≤99.6 wt %, or ≤99.4 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a and b, based on the weight of the composition.
W2] The process of any one of A]-V2] above, wherein the composition comprises ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥98.5 wt %, or ≥99.0 wt %, or ≥99.2 wt %, or ≥99.3 wt %, or ≥99.4 wt % of the sum of components a, b and c, based on the weight of the composition.
X2] The process of any one of A]-W2] above, wherein the composition comprises ≤100.0 wt %, or ≤99.9 wt %, or ≤99.8 wt %, or ≤99.7 wt %, or ≤99.6 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a, b and c, based on the weight of the composition.
Y2] The process of any one of A]-X2] above, wherein the composition is thermally treated at a temperature from ≥120° C., or ≥125° C., or ≥130° C., or ≥135° C., or ≥140° C., or ≥145° C., or ≥150° C. to ≤200° C., or ≤195° C., or ≤190° C., or ≤185° C., or ≤180° C.
Z2] The process of any one of A]-Y2] above, wherein component c is selected from the group consisting of triallyl isocyanurate (TAIC), 1,3,5,7-tetravinyl-1,3,5,7-tetramethylcyclotetrasiloxane (Vinyl D4), and combinations thereof.
A3] The process of any one of A]-Z2] above, wherein the composition, after thermal treatment at a temperature from 150° C. to 180° C., for 15 to 25 minutes, has a “MH-ML” value ≥1.0, or ≥1.5, or ≥2.0, or ≥2.5, or ≥3.0, or ≥3.5, or ≥4.0, or ≥4.5, or ≥5.0, or ≥5.5, or ≥6.0, or ≥6.5, or ≥6.7, or ≥7.0, or ≥7.5, or ≥8.0, or ≥9.0, or ≥10.0, or ≥10.5. Units=dN*m. The MH value and the ML value are determined by MDR as described herein.
B3] The process of any one of A]-A3] above, wherein the composition, after thermal treatment at a temperature from 150° C. to 180° C., for 15 to 25 minutes, has a “MH-ML” value ≤50.0, or ≤45.0, or ≤40.0, or ≤35.0, or ≤30.0, or ≤25.0, or ≤20.0, or ≤15.0, or ≤14.0, or ≤13.0, or ≤12.0, or ≤11.0, or ≤10.5, or ≤10.0, or ≤9.5, or ≤9.0, or ≤8.5, or ≤8.0, or ≤7.5, or ≤7.0, or ≤6.8. Units=dN*m.
C3] The process of any one of A]-B3] above, wherein the composition, after thermal treatment at a temperature from 150° C. to 180° C., for 15 to 25 minutes, has a [(MH−ML)/T90] value ≥0.10 dN*m/min, or ≥0.20 dN*m/min, or ≥0.30 dN*m/min, or ≥0.40 dN*m/min, or ≥0.50 dN*m/min, or ≥0.60 dN*m/min, or ≥0.70 dN*m/min, or ≥0.80 dN*m/min, or ≥0.90 dN*m/min, or ≥1.00 dN*m/min, or ≥1.50 dN*m/min, or ≥2.00 dN*m/min, or ≥2.50 dN*m/min, or ≥3.00 dN*m/min. The MH, ML and T90 values are determined by MDR as described herein.
D3] The process of any one of A]-C3] above, wherein the composition, after thermal treatment at a temperature from 150° C. to 180° C., for 15 to 25 minutes, has a [(MH−ML)/T90] value ≤20 dN*m/min, or ≤18 dN*m/min, or ≤16 dN*m/min, or ≤14 dN*m/min, or ≤12 dN*m/min, or ≤10 dN*m/min, or ≤8.0 dN*m/min, or ≤6.0 dN*m/min, or ≤4.0 dN*m/min, or ≤3.0 dN*m/min, or ≤2.54 dN*m/min.
E3] The process of any one of A]-D3] above, wherein the composition further comprises a thermoplastic polymer, different from the interpolymer of component a in one or more features, such as monomer(s) types and/or amounts, density, melt index (12), Mn, Mw, MWD, or any combination thereof, and further, in one or more features, such as monomer(s) types and/or amounts, Mn, Mw, MWD, or any combination thereof.
F3] The process of any one of A]-E3] above, wherein the composition further comprises an ethylene/alpha-olefin interpolymer or an ethylene/alpha-olefin copolymer.
G3] The process of F3] above, wherein the alpha-olefin of the ethylene/alpha-olefin interpolymer or copolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
H3] The process of any one of A]-G3] above, wherein the olefin/silane interpolymer of component a has a melting temperature (Tₘ) ≥0° C., or ≥5° C., or ≥10° C., or ≥15° C., or ≥20° C., or ≥25° C., or ≥30° C., or ≥35° C.
I3] The process of any one of A]-H3] above, wherein the olefin/silane interpolymer of component a has a melting temperature (Tₘ) ≤100° C., or ≤90° C., or ≤85° C., or ≤80° C., or ≤75° C., or ≤70° C., or ≤65° C.
J3] The process of any one of A]-I3] above, wherein the composition further comprises a filler and/or an oil.
K3] The process of any one of A]-J3] above, wherein the composition comprises ≤100 ppm, or ≤50 ppm, or ≤20 ppm, or ≤10 ppm, or ≤5.0 ppm of a Lewis acid (for example, a sulfonic acid), based on the weight of the composition.
L3] The process of any one of A]-K3] above, wherein the composition does not comprise a Lewis acid.
M3] The process of any one of A]-L3] above, wherein the composition comprises ≤100 ppm, or ≤50 ppm, or ≤20 ppm, or ≤10 ppm, or ≤5.0 ppm of a Lewis base, based on the weight of the composition.
N3] The process of any one of A]-M3] above, wherein the composition does not comprise a Lewis base.
O3] A crosslinked composition formed by the process of any one of A]-N3] above.
P3] An article comprising at least one component formed from the composition of 03] above.
Q3] The article of P3] above, wherein the article is a film.
R3] The article of P3] above, wherein the article is a solar cell module, a cable, a footwear component, an automotive part, a window profile, a tire, a tube, or a roofing membrane.
S3] A composition that comprises the following components:
a) at least one olefin/silane interpolymer comprising at least one (type) Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.
   T3] The composition of S3] above, wherein the olefin/silane interpolymer of component a is an ethylene/alpha-olefin/silane interpolymer or an ethylene/alpha-olefin/silane terpolymer.
   U3] The composition of T3] above, wherein the alpha-olefin of the olefin/silane interpolymer or further terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
   V3] The composition of any one of S3]-U3] above, wherein the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt %, or ≥1.5 wt % of the silane, based on the weight of the interpolymer.
   W3] The composition of any one of S3]-V3] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer.
   X3] The composition of any one of S3]-W3] above, wherein the interpolymer of component a comprises, in polymerized form, ≤5.0 wt %, or ≤4.5 wt %, or ≤4.0 wt %, or ≤3.0 wt %, or ≤2.0 wt %, or ≤1.5 wt % of the silane, based on the weight of the interpolymer.
   Y3] The composition of any one of S3]-X3] above, wherein the interpolymer of component a has a molecular weight distribution (MWD=Mw/Mn)≥1.5, or ≥1.6, or ≥1.7, or ≥1.8, or ≥1.9.
   Z3] The composition of any one of S3]-Y3] above, wherein the interpolymer of component a has a molecular weight distribution MWD≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.
   A4] The composition of any one of S3]-Z3] above, wherein the interpolymer of component a has a number average molecular weight (Mn)≥10,000 g/mol, or ≥12,000 g/mol, or ≥14,000 g/mol, or ≥16,000 g/mol, or ≥18,000 g/mol, or ≥20,000 g/mol, or ≥22,000 g/mol, or ≥24,000 g/mol, or ≥26,000 g/mol, or ≥28,000 g/mol, or ≥30,000 g/mol, or ≥32,000 g/mol.
   B4] The composition of any one of S3]-A4] above, wherein the interpolymer of component a has a number average molecular weight (Mn)≤100,000 g/mol, or ≤95,000 g/mol, or ≤90,000 g/mol, or ≤85,000 g/mol, or ≤80,000 g/mol, or ≤75,000 g/mol, or ≤70,000 g/mol, or ≤68,000 g/mol, or ≤66,000 g/mol, or ≤64,000 g/mol, or ≤62,000 g/mol, or ≤60,000 g/mol.
   C4] The composition of any one of S3]-B4] above, wherein the interpolymer of component a has a weight average molecular weight (Mw)≥20,000 g/mol, or ≥25,000 g/mol, or ≥30,000 g/mol, or ≥35,000 g/mol, or ≥40,000 g/mol, or ≥45,000 g/mol, or ≥50,000 g/mol, or ≥52,000 g/mol, or ≥54,000 g/mol, or ≥56,000 g/mol, or ≥58,000 g/mol, or ≥60,000 g/mol, or ≥62,000 g/mol.
   D4] The composition of any one of S3]-C4] above, wherein the interpolymer of component a has a weight average molecular weight (Mw)≤300,000 g/mol, or ≤250,000 g/mol, or ≤200,000 g/mol, or ≤190,000 g/mol, or ≤180,000 g/mol, or ≤170,000 g/mol, or ≤160,000 g/mol, or ≤150,000 g/mol, or ≤148,000 g/mol, or ≤146,000 g/mol, or ≤144,000 g/mol, or ≤142,000 g/mol, or ≤140,000 g/mol, or ≤138,000 g/mol.
   E4] The composition of any one of S3]-D4] above, wherein the interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.870 g/cc, or ≥0.874 g/cc, or ≥0.876 g/cc, or ≥0.878 g/cc (1 cc=1 cm³).
   F4] The composition of any one of S3]-E4] above, wherein the interpolymer of component a has a density ≤0.950 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc.
   G4] The composition of any one of S3]-F4] above, wherein the interpolymer of component a has a melt index (12)≥0.5 dg/min, or ≥1.0 dg/min, or ≥2.0 dg/min, or ≥5.0 dg/min, or ≥10 dg/min, or ≥15 dg/min.
   H4] The composition of any one of S3]-G4] above, wherein the interpolymer of component a has a melt index (12)≤1,000 dg/min, or ≤500 dg/min, or ≤250 dg/min, or ≤100 dg/min, or ≤50 dg/min, or ≤20 dg/min.
   I4] The composition of any one of S3]-H4] above, wherein the interpolymer of component a has an I10/I2 ratio ≥6.0, or ≥7.0, or ≥8.0, or ≥9.0, or ≥10.
   J4] The composition of any one of S3]-I4] above, wherein the interpolymer of component a has an I10/I2 ratio≤30, or ≤25, or ≤20, or ≤15, or ≤12.
   K4] The composition of any one of S3]-J4] above, wherein the silane is derived from a silane monomer selected from Formula 1, as described above.
   L4] The composition of K4] above, wherein, for Formula 1, x is from 0 to 10, or from 0 to 8, or from 0 to 6, or from 0 to 4, or from 0 to 2, or 0 or 1, or 0.
   M4] The interpolymer of K4] or L4] above, wherein, for Formula 1, A is a C2-C50 alkenyl group, and further a C2-C40 alkenyl group, or a C2-C30 alkenyl group, or a C2-C20 alkenyl group.
   N4] The composition of any one of K4]-M4] above, wherein, for Formula 1, A is selected from the following structures i)-iv):
i) R¹R²C═CR³—, as described above;
ii) R¹R²C═CR³—(CR⁴R⁵)ₙ—, as described above;
ii)

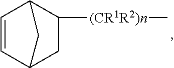

as described above; or
iv)

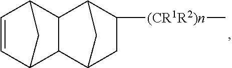

as described above.
O4] The interpolymer of any one of K4]-N4] above, wherein, for Formula 1, A is selected from the following structures i)-iv):
i) H₂C═CH—;
ii) H₂C═CH—(CH₂)ₙ—, as described above;
iii)

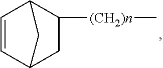

as described above; or
iv)

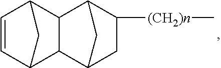

as described above.
P4] The composition of any one of K4]-O4] above, wherein, for Formula 1, B is an alkyl, or a C1-C5 alkyl, or a C1-C4 alkyl, or a C1-C3 alkyl, or a C1-C2 alkyl, or methyl.
Q4] The composition of any one of K4]-P4] above, wherein, for Formula 1, C is an alkyl, or a C1-C5 alkyl, or a C1-C4 alkyl, or a C1-C3 alkyl, or a C1-C2 alkyl, or methyl.
R4] The composition of any one of K4]-Q4] above, wherein, for Formula 1, E is an alkyl, or a C1-C5 alkyl, or a C1-C4 alkyl, or a C1-C3 alkyl, or a C1-C2 alkyl, or methyl. S4] The composition of any one of K4]-R⁴] above, wherein, for Formula 1, F is an alkyl, or a C1-C5 alkyl, or a C1-C4 alkyl, or a C1-C3 alkyl, or a C1-C2 alkyl, or methyl.
T4] The composition of any one of K4]-S4] above, wherein Formula 1 is selected from compounds s1) through s16), as described above.
U4] The composition of any one of K4]-T4] above, wherein Formula 1 is selected from structures s1) to s8), as described above.
V4] The composition of any one of K4]-T4] above, wherein Formula 1 is selected from structures $9) to s16), as described above.
W4] The composition of any one of S3]-V4] above, wherein the silane is derived from a silane monomer selected from the following compounds: (5-hexenyl-dimethylsilane (HDMS), 7-octenyldimethylsilane (ODMS), allyldimethylsilane, 3-butenyl-dimethylsilane, 1-(but-3-en-1-yl)-1,1,3,3-tetramethyl-disiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethylsilane (NorDMS) or 1-(2-bicyclo[2.2.1]hept-5-en-2-yl)ethyl)-1,1,3,3-tetra-methyldisiloxane (NorMMH), and any combination thereof.
X4] The composition of any one of S3]-W4] above, wherein the composition has a weight ratio of component a to component b ≥100, or ≥200, or ≥300, or ≥400, or ≥500, or ≥600, or ≥700, or ≥800, or ≥900, or ≥1000, or ≥1100, or ≥1200, or ≥1300, or ≥1400, or ≥1500, or ≥1600, or ≥1700, or ≥1800, or ≥1900, or ≥2000.
Y4] The composition of any one of S3]-X4] above, wherein the composition has a weight ratio of component a to component b ≤3000, or ≤2500, or ≤2000.
Z4] The composition of any one of S3]-Y4] above, wherein the composition has a mole ratio of active oxygen atom to carbon-carbon double bond of ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7, based on the active oxygen atom content of component b and the carbon-carbon double bond content of component c.
A5] The composition of Z4] above, wherein the composition has a mole ratio of active oxygen atom to carbon-carbon double bond of ≤0.7, or ≤0.6, or ≤0.5, based on the active oxygen atom content of component b and the carbon-carbon double bond content of component c.
B5] The composition of Z4] or A5] above, wherein the composition has a weight ratio of component c to component b of ≥0.7, or ≥1.0, or ≥1.4, or ≥2.0, or ≥3.0, or ≥4.0, or ≥5.0, or ≥6.0, or ≥7.0, or ≥8.0, or ≥9.0, or ≥10.0, or ≥11.0, or ≥12.0, or ≥15.0, or ≥20.0, or ≥25.0, or ≥30.0, or ≥35.0, or ≥40.0, or ≥45.0, or ≥50.0, or ≥55.0, or ≥60.0, or ≥65.0, or ≥70.0.
C5] The composition of any one of S3]-B5] above, wherein the composition has a weight ratio of component c to component b of ≤100.0, or ≤90.0, or ≤80.0, or ≤70.0, or ≤65.0. D5] The composition of any one of S3]-C5] above, wherein the composition has a mole ratio of “the active oxygen atom in component b” to component c ≥0.02, or ≥0.03, or ≥0.04, or ≥0.05, or ≥0.06, or ≥0.07, or ≥0.08, or ≥0.09, or ≥0.1, or ≥0.2, or ≥0.3, or ≥0.4, or ≥0.5, or ≥0.6, or ≥0.7.
E5] The composition of any one of Z4]-D5] above, wherein the composition has a mole ratio of “the active oxygen atom in component b” to component c ≤0.7, or ≤0.6, or ≤0.5.
F5] The composition of any one of Z4]-E5] above, wherein the olefin/silane interpolymer of component a is an olefin/silane interpolymer formed in the presence of a bis-biphenyl-phenoxy metal complex.
G5] The composition of any one of S3]-F5] above, wherein the composition comprises ≥20.0 wt %, or ≥30.0 wt %, or ≥40.0 wt %, or ≥45.0 wt %, or ≥50.0 wt %, or ≥55.0 wt %, or ≥60.0 wt %, or ≥65.0 wt %, or ≥70.0 wt %, or ≥75.0 wt %, or ≥80.0 wt %, or ≥85.0 wt %, or ≥90.0 wt %, or ≥95.0 wt %, or ≥96.0 wt %, or ≥97.0 wt %, or ≥98.0 wt %, or ≥99.0 wt % of component a, based on the weight of the composition.
H5] The composition of any one of S3]-G5] above, wherein the composition comprises ≤99.9 wt %, or ≤99.8 wt %, or ≤99.6 wt %, or ≤99.4 wt %, or ≤99.2 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of component a, based on the weight of the composition.
I5] The composition of any one of S3]-H5] above, wherein the composition comprises ≥0.01 wt %, or ≥0.05 wt %, or ≥0.10 wt %, or ≥0.15 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt % of component b, based on the weight of the composition.
J5] The composition of any one of S3]-I5] above, wherein the composition comprises ≤5.0 wt %, or ≤4.0 wt %, or ≤3.0 wt %, or ≤2.0 wt %, or ≤1.50 wt %, or ≤1.0 wt % of component b, based on the weight of the composition.
K5] The composition of any one of S3]-J5] above, wherein the composition comprises ≥0.1 wt %, or ≥0.5 wt %, or ≥0.9 wt %, or ≥1.00 wt %, or ≥1.50 wt %, or ≥1.70 wt %, or ≥1.90 wt %, or ≥2.0 wt %, or ≥2.50 wt %, or ≥3.0 wt %, or ≥3.14 wt %, or ≥3.15 wt %, or ≥3.20 wt % of component c, based on the weight of the composition.
L5] The composition of any one of S3]-K5] above, wherein the composition comprises ≤5.0 wt %, or ≤4.0 wt %, or ≤3.50 wt %, or ≤3.20 wt %, or ≤3.14 wt % of component c, based on the weight of the composition.
M5] The composition of any one of S3]-L5] above, wherein the composition comprises ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥97.0 wt %, or ≥98.0 wt %, or ≥98.2 wt %, or ≥98.4 wt %, or ≥98.6 wt %, or ≥98.8 wt %, or ≥99.0 wt % the sum of components a and b, based on the weight of the composition.
N5] The composition of any one of S3]-M5] above, wherein the composition comprises ≤100.0 wt %, or ≤99.0 wt %, or ≤99.8 wt %, or ≤99.6 wt %, or ≤99.4 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a and b, based on the weight of the composition.
O5] The composition of any one of S3]-N5] above, wherein the composition comprises ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥98.5 wt %, or ≥99.0 wt %, or ≥99.2 wt %, or ≥99.3 wt %, or ≥99.4 wt % of the sum of components a, b and c, based on the weight of the composition.
P5] The composition of any one of S3]-O5] above, wherein the composition comprises ≤100.0 wt %, or ≤99.9 wt %, or ≤99.8 wt %, or ≤99.7 wt %, or ≤99.6 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a, b and c, based on the weight of the composition.
Q5] The composition of any one of S3]-P5] above, wherein the composition, after thermal treatment at a temperature from 150° C. to 180° C., for 15 to 25 minutes, has a “MH-ML” value ≥1.0, or ≥1.5, or ≥2.0, or ≥2.5, or ≥3.0, or ≥3.5, or ≥4.0, or ≥4.5, or ≥5.0, or ≥5.5, or ≥6.0, or ≥6.5, or ≥6.7, or ≥7.0, or ≥7.5, or ≥8.0, or ≥9.0, or ≥10.0, or ≥10.5. Units=dN*m. The MH value and the ML value are determined by MDR as described herein.
R5] The composition of any one of S3]-Q5] above, wherein the composition, after thermal treatment at a temperature from 150° C. to 180° C., for 15 to 25 minutes, has a “MH-ML” value ≤50.0, or ≤45.0, or ≤40.0, or ≤35.0, or ≤30.0, or ≤25.0, or ≤20.0, or ≤15.0, or ≤14.0, or ≤13.0, or ≤12.0, or ≤11.0, or ≤10.5, or ≤10.0, or ≤9.5, or ≤9.0, or ≤8.5, or ≤8.0, or ≤7.5, or ≤7.0, or ≤6.8. Units=dN*m.
S5] The composition of any one of S3]-R5] above, wherein the composition, after thermal treatment at a temperature from 150° C. to 180° C., for 15 to 25 minutes, has a [(MH−ML)/T90] value ≥0.10 dN*m/min, or ≥0.20 dN*m/min, or ≥0.30 dN*m/min, or ≥0.40 dN*m/min, or ≥0.50 dN*m/min, or ≥0.60 dN*m/min, or ≥0.70 dN*m/min, or ≥0.80 dN*m/min, or ≥0.90 dN*m/min, or ≥1.00 dN*m/min, or ≥1.50 dN*m/min, or ≥2.00 dN*m/min, or ≥2.50 dN*m/min, or ≥3.00 dN*m/min. The MH, ML and T90 values are determined by MDR as described herein.
T5] The composition of any one of S3]-S5] above, wherein the composition, after thermal treatment at a temperature from 150° C. to 180° C., for 15 to 25 minutes, has a [(MH−ML)/T90] value ≤20 dN*m/min, or ≤18 dN*m/min, or ≤16 dN*m/min, or ≤14 dN*m/min, or ≤12 dN*m/min, or ≤10 dN*m/min, or ≤8.0 dN*m/min, or ≤6.0 dN*m/min, or ≤4.0 dN*m/min, or ≤3.0 dN*m/min, or ≤2.54 dN*m/min.
U5] The composition of any one of S3]-T5] above, wherein the composition further comprises a thermoplastic polymer, different from the interpolymer of component a in one or more features, such as monomer(s) types and/or amounts, density, melt index (12), Mn, Mw, MWD, or any combination thereof, and further, in one or more features, such as monomer(s) types and/or amounts, Mn, Mw, MWD, or any combination thereof.
V5] The composition of any one of S3]-U5] above, wherein the composition further comprises an ethylene/alpha-olefin interpolymer or an ethylene/alpha-olefin copolymer.
W5] The composition of V5] above, wherein the alpha-olefin of the ethylene/alpha-olefin interpolymer, and further a copolymer, is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
X5] The composition of any one of S3]-W5] above, wherein the olefin/silane interpolymer of component a has a melting temperature (Tₘ) ≥0° C., or ≥5° C., or ≥10° C., or ≥15° C., or ≥20° C., or ≥25° C., or ≥30° C., or ≥35° C.
Y5] The composition of any one of S3]-X5] above, wherein the olefin/silane interpolymer of component a has a melting temperature (Tₘ) ≤100° C., or ≤90° C., or ≤85° C., or ≤80° C., or ≤75° C., or ≤70° C., or ≤65° C.
Z5] The composition of any one of S3]-Y5] above, wherein the composition further comprises a filler and/or an oil.
A6] The composition of any one of S3]-Z5] above, wherein the composition comprises ≤100 ppm, or ≤50 ppm, or ≤20 ppm, or ≤10 ppm, or ≤5.0 ppm of a Lewis acid (for example, a sulfonic acid), based on the weight of the composition.
B6] The composition of any one of S3]-A6] above, wherein the composition does not comprise a Lewis acid.
C6] The composition of any one of S3]-B6] above, wherein the composition comprises ≤100 ppm, or ≤50 ppm, or ≤20 ppm, or ≤10 ppm, or ≤5.0 ppm of a Lewis base, based on the weight of the composition.
D6] The composition of any one of S3]-C6] above, wherein the composition does not comprise a Lewis base.
E6] The composition of any one of S3]-D6] above, wherein component c is selected from the group consisting of triallyl isocyanurate (TAIC) and 1,3,5,7-tetravinyl-1,3,5,7-tetramethylcyclotetrasiloxane (Vinyl D4).
F6] A crosslinked composition formed the composition of any one of S3]-E6] above.
G6] An article comprising at least one component formed from the composition of any one of S3]-F6] above.
H6] The article of G6] above, wherein the article is a film.
I6] The article of G6] above, wherein the article is a solar cell module, a cable, a footwear component, an automotive part, a window profile, a tire, a tube/hose, or a roofing membrane.

### Test Methods

### Gel Permeation Chromatography

The chromatographic system consisted of a PolymerChar GPC-IR (Valencia, Spain) high temperature GPC chromatograph, equipped with an internal IR5 infra-red detector (IR5).

The autosampler oven compartment was set at 160° Celsius, and the column compartment was set at 150° Celsius. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent

Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1), where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB, and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max} )}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{( {RV}_{Peak max} - Front Peak {RV}_{one tenth height} )} , \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged, septa-capped vial, via the PolymerChar high temperature autosampler. The samples were dissolved for two hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ5 )$$

$$and$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} . \qquad ( EQ6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

### Melt Index

The melt index I2 of an ethylene-based polymer is measured in accordance with ASTM D-1238, condition 190° C./2.16 kg (melt index I10 at 190° C./10.0 kg). The I10/I2 was calculated from the ratio of I10 to the I2. The melt flow rate MFR of a propylene-based polymer is measured in accordance with ASTM D-1238, condition 230° C./2.16 kg.

### Density

ASTM D4703 was used to make a polymer plaque for density analysis. ASTM D792, Method B, was used to measure the density of each polymer.

### NMR (13C and 1H) Characterization of Terpolymers

For ¹³C NMR experiments, samples were dissolved, in 10 mm NMR tubes, in tetrachloroethane-d₂ (with or without 0.025 M Cr(acac)₃). The concentration was approximately 300 mg/2.8 mL. Each tube was then heated in a heating block set at 110° C. The sample tube was repeatedly vortexed and heated to achieve a homogeneous flowing fluid. The ¹³C NMR spectrum was taken on a BRUKER AVANCE 600 MHz spectrometer, equipped with a 10 mm C/H DUAL cryoprobe. The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The ¹³C NMR spectrum was referenced to “74.5 ppm” for the resonance peak of the solvent. For a sample with Cr, the data was taken with a “7 seconds relaxation delay” and 1024 scans. The “mol % octene (or other alpha-olefin)” was calculated based on the CH/CH3 carbons associated with octene (or other alpha-olefin) versus the integration of CH2 associated with ethylene units.

For ¹H NMR experiments, each sample was dissolved, in 8 mm NMR tubes, in tetrachloroethane-d₂ (with or without 0.001 M Cr(acac)₃). The concentration was approximately 100 mg/1.8 mL. Each tube was then heated in a heating block set at 110° C. The sample tube was repeatedly vortexed and heated to achieve a homogeneous flowing fluid. The ¹H NMR spectrum was taken on a BRUKER AVANCE 600 MHz spectrometer, equipped with a 10 mm C/H DUAL cryoprobe. A standard single pulse ¹H NMR experiment was performed. The following acquisition parameters were used: 70 seconds relaxation delay, 90 degree pulse of 17.2 μs, 32 scans. The spectrum was centered at 1.3 ppm, with a spectral width of 20 ppm. All measurements were taken, without sample spinning, at 110° C. The ¹H NMR spectrum was referenced to “5.99 ppm” for the resonance peak of the solvent (residual protonated tetrachloroethane). For a sample with Cr, the data was taken with a “16 seconds relaxation delay” and 128 scans. The “mol % silane (silane monomer)” was calculated based on the integration of SiMe proton resonances, versus the integration of CH2 protons associated with ethylene units and CH3 protons associated with octene units.

### Moving Die Rheometer (MDR)

The evaluation of the peroxide reaction to the olefin/silane interpolymer was evaluated through Moving Die Rheometer testing (MDR), as follows. Crosslinking characteristics were measured using an Alpha Technologies Moving Die Rheometer (MDR) 2000 E, according to ASTM D5289, with amplitude of the oscillation of 0.5 deg of arc. For each composition, the MDR was loaded with approximately 4.5 g of the formulated composition (soaked or imbibed pellets; see Compounding Procedures below). The MDR was run at 160° C. (for TBEC) for 15 minutes, at 150° C. (for Enox CH-80MO) for 25 min and at 180° C. (for Luperox 101) for 25 min at an oscillation frequency of 100 CPM (1.67 Hz) and an oscillation angle of 0.5 degree (7% strain). The minimum torque (ML) maximum torque (MH) exerted by the MDR during the testing interval are reported in dNm. The difference between MH and ML is indicative of the extent of crosslinking, with the greater the difference reflecting a greater extent of crosslinking. The time it takes for torque to reach 90% of MH (t90) is reported in minutes. The time required for the increase of 1 (ts1) points from minimum torque is recorded in minutes. The ts1 values are indicative of the time required for the crosslinking process to begin. A shorter time indicates crosslinking initiates faster.

### Differential Scanning Calorimetry (DSC)

Differential Scanning calorimetry (DSC) is used to measure Tₘ, T_{c}, T_{g} and crystallinity in ethylene-based (PE) polymer samples and propylene-based (PP) polymer samples. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 180° C. for PE (230° C. for PP). The sample was kept at this temperature for three minutes. Then the sample was cooled at a rate of 10° C./min to −90° C. for PE (−60° C. for PP), and kept isothermally at that temperature for three minutes. The sample was next heated at a rate of 10° C./min, until complete melting (second heat). Unless otherwise stated, melting point (Tₘ) and the glass transition temperature (T_{g}) of each polymer were determined from the second heat curve, and the crystallization temperature (T_{c}) was determined from the first cooling curve. The respective peak temperatures for the Tₘ and the T_{c} were recorded. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)). In DSC measurements, it is common that multiple Tₘ peaks are observed, and here, the highest temperature peak as the Tₘ of the polymer is recorded.

### Experimental

### Materials

Luperox TBEC: a peroxide (tert-Butylperoxy 2-ethylhexyl carbonate) available from Arkema;
Luperox 101: a peroxide (2,5-Bis(tert-butylperoxy)-2,5-dimethylhexane) available from Arkema;
Enox CH-80MO: a peroxide (1,1-di-(tert-butylperoxy)cyclohexane, assay 80%) available from Chinasun Specialty Products Co., Ltd.;
Vinyl D4: a crosslinking coagent (1,3,5,7-tetravinyl-1,3,5,7-tetramethylcyclotetrasiloxane) available from The Dow Chemical Company;
TAIC: a crosslinking coagent (triallyl isocyanurate) available from Farida Chemicals Co., Ltd.;
ENGAGE™ 8669: Polyolefin Elastomer (ethylene/1-octene copolymer) available from The Dow Chemical Company, density=0.873 g/cm³ (ASTM D792), I2=14.0 g/10 min (ASTM D1238, at 190° C./2.16 kg); 0 wt % SiH;
SiH POE D: an ethylene/octene/silane terpolymer, density=0.873 g/cc, I2=0.8 g/10 min, 1.5 wt % of HDMS;
SiH POE G: an ethylene/octene/silane terpolymer, density=0.879 g/cc, I2=15.7 g/10 min, 4.0 wt % of HDMS;
POE D: an ethylene/octene copolymer, density=0.871 g/cc, I2=1.2 g/10 min, 0 wt % SiH.

### Polymer Syntheses and Properties

The interpolymers SiH-POE D, SiH-POE G, and POE D were each prepared in a one gallon, polymerization reactor that was hydraulically full, and operated at steady state conditions. The solvent was ISOPAR-E, supplied by the ExxonMobil Chemical Company. The 5-hexenyldimethylsilane (HDMS) supplied by Gelest, was used as a termonomer, and was purified over AZ-300 alumina supplied by UOP Honeywell, prior to use. HDMS was fed to the reactor as a 22 wt % solution in ISOPAR-E. The reactor temperature was measured at or near the exit of the reactor. The interpolymer was isolated and pelletized. Polymerization conditions are listed in Table 1B-1D, and catalysts and co-catalysts are listed in Table 1A. The polymer properties of each ethylene/octene/silane terpolymer (SiH-POE) and the ethylene/octene copolymer (POE) are shown in Tables 2A and 2B.

TABLE 1A
Catalysts and Co-catalysts

| Catalyst (CAT) | Description |
|---|---|
| PE CAT 1 (WO2012/027448) | 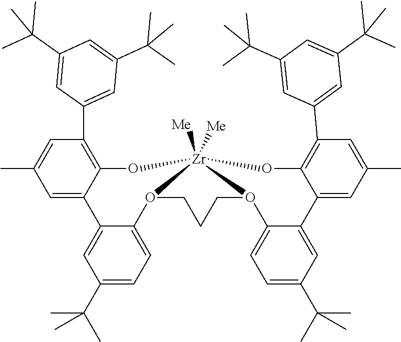 |
| PE CAT 2 (WO2012/027448) | 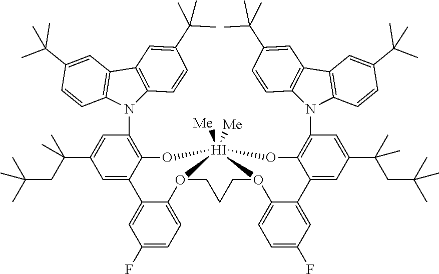 |
| Cocatalyst | |
| CoCAT-1 | A mixture of methyldi(C14-18 alkyl)ammonium salts of |
| | tetrakis(pentafluorophenyl)borate, prepared by reaction of a long chain trialkylamine |
| | (Armeen ™ M2HT, available from Akzo-Nobel, Inc.), HCl and Li[B(C6F5)4], |
| | substantially as disclosed in USP 5,919,983, Ex. 2 (no further purification performed) |
| | (Boulder Scientific). |
| CoCAT-2 | Modified methylalumoxane (MMAO) Type 3A (no further purification performed) |
| | (Akzo Nobel). |

TABLE 1B
Polymerization Conditions to Produce Noted SiH-POEs and POE-D

| | | Reactor | | | | | | |
|---|---|---|---|---|---|---|---|---|
| | Reactor | Pressure, | Solvent, | Ethylene, | Octene, | HDMS, | Hydrogen, | ethylene |
| | Temp., ° C. | psig | lb/hr | lb/hr | lb/hr | lb/h | sccm | conversion, % |
| SiH- | 170 | 729 | 38 | 3.8 | 5.0 | 1.4 | 192 | 83 |
| POE | | | | | | | | |
| D | | | | | | | | |
| SiH- | 170 | 725 | 17 | 3.6 | 4.2 | 3.1 | 89 | 89 |
| POE | | | | | | | | |
| G | | | | | | | | |
| POE | 170 | 728 | 39 | 3.8 | 5.4 | 0 | 162 | 83 |
| D | | | | | | | | |

TABLE 1C
Catalyst Feed Flows and Efficiency

| | | | | Overall Catalyst Efficiency, (g |
|---|---|---|---|---|
| | | Catalyst Solution | Catalyst Solution | interpolymer/g total catalyst |
| | Catalyst | Flow, lb/hr | Metal Conc., ppm* | metal) |
| SiH- | PE CAT 2 | 0.33 | 3.96 | 3,911,000 |
| POE | | | | |
| D | | | | |
| SiH- | PE CAT 1 | 0.17 | 14.68 | 1,798,000 |
| POE | | | | |
| G | | | | |
| POE | PE CAT 2 | 0.33 | 3.96 | 3,939,000 |
| D | | | | |

*The “ppm” amount based on the weight of the respective catalyst feed solution.

TABLE 1D
Cocatalyst Feed Flows

| | | | | CoCAT 2 |
|---|---|---|---|---|
| | CoCAT 1 | CoCAT 1 | CoCAT 2 | Solution |
| | Solution | Solution | Solution | Conc. ppm |
| | Flow, lb/hr | Conc., ppm* | Flow, lb/hr | Al** |
| SiH-POE | 0.34 | 31.25 | 0.30 | 32.2 |
| D | | | | |
| SiH-POE | 0.29 | 154.8 | 0.29 | 14.2 |
| G | | | | |
| POE D | 0.33 | 31.25 | 0.31 | 32.2 |

*The “ppm” amount based on the weight of the co-catalyst feed solution.
**The “ppm” amount of Al based on the weight of the co-catalyst feed solution.

TABLE 2A
Polymer Properties

| Resin Description | | | | | Silane Information | | |
|---|---|---|---|---|---|---|---|
| | Density | MI | Octene | Tₘ | Silane | Silane | Silane |
| Resin | (g/cc) | (dg/min) | (mol %) | (C. °) | Type | mol %* | wt %** |
| SiH-POE D | 0.873 | 0.8 | 11.0 | 64.5 | HDMS | 0.4 | 1.5 |
| SiH-POE G | 0.879 | 15.7 | 8.6 | 75.4 | HMDS | 1.0 | 4.0 |
| POE D | 0.87 | 1.2 | 12.0 | 61.9 | — | — | — |

*Mol % silane based on total moles of monomers in polymer, and determined by 1H NMR.
**Wt % silane calculated from the mol %, and based on the weight of the interpolymer.
HDMS = 5-Hexenyldimethylsilane.

TABLE 2B
Polymer Properties (Conventional GPC)

| Resin | Mn (kg/mol) | Mw (kg/mol) | Mw/Mn |
|---|---|---|---|
| SiH-POE D | 49 | 108 | 2.2 |
| SiH-POE G | 25 | 53 | 2.1 |
| POE D | 52 | 112 | 2.2 |

### Improved Peroxide Crosslinking of Inventive Compositions

Polymer compositions (weight parts per hundred resin/rubber-phr) and curing properties are listed in Tables 3-7. For each composition, the polymer resins were first soaked with the solution of peroxide and coagent in fluorinated bottles on a roller at 50° C. (for vinyl D4) and 60° C. (for TAIC) for 24 hours. The soaked pellets were used for the above-described MDR test for curing evaluation.

Inventive Examples 1-18 (IE-1 to IE-18) represent the inventive composition of the present application where each of the compositions comprises at least one olefin/silane interpolymer comprising at least one Si—H group, at least one peroxide, and at least one crosslinking coagent, wherein each composition has a mole ratio of active oxygen atom to carbon-carbon double bond of ≥0.02 and ≤0.7, based on the active oxygen atom content of component b and the carbon-carbon double bond content of component c. In other words, IE-1 to IE-18 each have reduced peroxide levels such that the amount of coagent is actually higher than the amount of peroxide. Thus, it is surprising that each of IE-1 to IE-18 is able to achieve relatively high curing levels and fast curing despite the reduced amount of peroxide.

In contrast, as seen in Comparative Examples 1-18 (CE-1 to CE-18), compositions with conventional POE's (ENGAGE™ 8669 and POE D) are negatively affected by the reduced peroxide levels in that they are unable to achieve as high of a curing level compared to the inventive examples or as fast of a crosslinking rate compared to the inventive examples. Thus, the present application is inventive over the state of the art in that it provides a solution to further reduce peroxide loading level while still achieving a high curing level.

TABLE 3
Compositions (phr)

| | IE-1 | CE-1 | IE-2 | CE-2 | IE-3 | CE-3 | IE-4 | CE-4 |
|---|---|---|---|---|---|---|---|---|
| SiH-POE G | 100 | | 100 | | 100 | | 100 | |
| ENGAGE ™ 8669 | | 100 | | 100 | | 100 | | 100 |
| Luperox TBEC | 1 | 1 | 0.7 | 0.7 | 0.55 | 0.55 | 0.4 | 0.4 |
| Vinyl D4 | 1.4 | 1.4 | 1.9 | 1.9 | 2.2 | 2.2 | 2.5 | 2.5 |
| Grand Total | 102.4 | 102.4 | 102.6 | 102.6 | 102.75 | 102.75 | 102.9 | 102.9 |
| Mole ratio of active | 0.5 | 0.5 | 0.26 | 0.26 | 0.18 | 0.18 | 0.11 | 0.11 |
| oxygen atom to carbon- | | | | | | | | |
| carbon double bond | | | | | | | | |

MDR at 160° C. for 15 min

| | | | | | | | | |
|---|---|---|---|---|---|---|---|---|
| ML, dN*m | 6.49 | 5.36 | 6.72 | 4.66 | 6.66 | 4.17 | 5.54 | 2.58 |
| MH, dN*m | 0.02 | 0.02 | 0.01 | 0.01 | 0.04 | 0.07 | 0.01 | 0.02 |
| MH-ML, dN*m | 6.47 | 5.34 | 6.71 | 4.65 | 6.62 | 4.10 | 5.53 | 2.56 |
| T90, min | 2.54 | 3.36 | 3.19 | 4.14 | 4.24 | 5.36 | 6.58 | 7.22 |
| TS1 | 0.707 | 0.792 | 0.913 | 1.147 | 1.092 | 1.452 | 1.52 | 2.29 |

TABLE 4
Compositions (phr)

| | IE-5 | CE-5 | IE-6 | CE-6 | IE-7 | CE-7 | IE-8 | CE-8 |
|---|---|---|---|---|---|---|---|---|
| SiH-POE G | 100 | | 100 | | 100 | | 100 | |
| ENGAGE ™ 8669 | | 100 | | 100 | | 100 | | 100 |
| Luperox TBEC | 0.5 | 0.5 | 0.25 | 0.25 | 0.2 | 0.2 | 0.15 | 0.15 |
| TAIC | 1.0 | 1.0 | 1.35 | 1.35 | 1.5 | 1.5 | 1.8 | 1.8 |
| | 101.5 | 101.5 | 101.6 | 101.6 | 101.7 | 101.7 | 101.95 | 101.95 |
| Mole ratio of active | 0.34 | 0.34 | 0.13 | 0.13 | 0.09 | 0.09 | 0.06 | 0.06 |
| oxygen atom to carbon- | | | | | | | | |
| carbon double bond | | | | | | | | |

MDR at 160° C. for 15 min

| | | | | | | | | |
|---|---|---|---|---|---|---|---|---|
| ML, dN*m | 0 | 0.06 | 0.06 | 0.06 | 0.07 | 0.06 | 0.06 | 0.06 |
| MH, dN*m | 5.32 | 3.27 | 4.61 | 2.66 | 4.63 | 2.04 | 4.45 | 1.54 |
| MH-ML, dN*m | 5.32 | 3.21 | 4.55 | 2.6 | 4.56 | 1.98 | 4.39 | 1.48 |
| T90, min | 2.34 | 4.24 | 3.16 | 5.73 | 3.58 | 6.83 | 7.43 | 8.02 |
| TS1 | 0.77 | 1.19 | 1.18 | 1.98 | 1.37 | 2.98 | 2.32 | 4.34 |

TABLE 5
Compositions (phr)

| | IE-9 | CE-9 | IE-10 | CE-10 | IE-11 | CE-11 |
|---|---|---|---|---|---|---|
| SiH-POE G | 100 | | 100 | | 100 | |
| ENGAGE ™ 8669 | | 100 | | 100 | | 100 |
| Enox CH-80MO | 0.50 | 0.50 | 0.40 | 0.40 | 0.28 | 0.28 |
| Vinyl D4 | 2.00 | 2.00 | 2.26 | 2.26 | 2.56 | 2.56 |
| Grand Total | 102.5 | 102.5 | 102.66 | 102.66 | 102.84 | 102.84 |
| Mole ratio of active | 0.27 | 0.27 | 0.19 | 0.19 | 0.12 | 0.12 |
| oxygen atom to carbon- | | | | | | |
| carbon double bond | | | | | | |

MDR at 150° C. for 25 min

| | | | | | | |
|---|---|---|---|---|---|---|
| ML, dN*m | 0.03 | 0.03 | 0.03 | 0.03 | 0.03 | 0.03 |
| MH, dN*m | 5.21 | 3.2 | 4.88 | 2.41 | 4.69 | 0.94 |
| MH-ML, dN*m | 5.18 | 3.17 | 4.85 | 2.38 | 4.66 | 0.91 |
| T90, min | 6.59 | 8.07 | 8.53 | 12.26 | 11.64 | 15.49 |
| TS1 | 1.91 | 2.803 | 2.602 | 4.665 | 3.107 | NA |

TABLE 6

| | | | |
|---|---|---|---|
| IE-12 | CE-12 | IE-13 | CE-13 |

Compositions (phr)

| | | | | |
|---|---|---|---|---|
| SiH-POE D | 100 | | 100 | |
| POE D | | 100 | | 100 |
| Luperox TBEC | 0.44 | 0.44 | 0.32 | 0.32 |
| Vinyl D4 | 1.76 | 1.76 | 2.00 | 2.00 |
| | 102.2 | 102.2 | 102.32 | 102.32 |
| Mole ratio of active | 0.18 | 0.18 | 0.11 | 0.11 |
| oxygen atom to carbon- | | | | |
| carbon double bond | | | | |

MDR at 160° C. for 15 min

| | | | | |
|---|---|---|---|---|
| ML, dN*m | 0.81 | 0.43 | 0.5 | 0.39 |
| MH, dN*m | 7.46 | 6.29 | 6.29 | 4.21 |
| MH-ML, dN*m | 6.65 | 5.86 | 5.79 | 3.82 |
| T90, min | 4.11 | 4.12 | 5.56 | 6.02 |
| TS1 | 0.633 | 0.885 | 1.002 | 1.343 |

TABLE 7
Compositions (phr)

| | IE14 | CE14 | IE15 | CE15 | IE16 | CE16 | IE17 | CE17 | IE18 | CE18 |
|---|---|---|---|---|---|---|---|---|---|---|
| SiH-POE G | 100 | | 100 | | 100 | | 100 | | 100 | |
| ENGAGE ™ | | 100 | | 100 | | 100 | | 100 | | 100 |
| 8669 | | | | | | | | | | |
| Luperox | 0.12 | 0.12 | 0.08 | 0.08 | 0.05 | 0.05 | 0.11 | 0.11 | 0.06 | 0.06 |
| 101 | | | | | | | | | | |
| Vinyl D4 | 2.92 | 2.92 | 3.10 | 3.10 | 3.25 | 3.25 | | | | |
| TAIC | | | | | | | 1.35 | 1.35 | 1.50 | 1.50 |
| | 103.04 | 103.04 | 103.18 | 103.18 | 103.3 | 103.3 | 101.46 | 101.46 | 101.56 | 101.56 |
| Mole ratio | 0.05 | 0.05 | 0.03 | 0.03 | 0.02 | 0.02 | 0.09 | 0.09 | 0.05 | 0.05 |
| of active | | | | | | | | | | |
| oxygen | | | | | | | | | | |
| atom to | | | | | | | | | | |
| carbon- | | | | | | | | | | |
| carbon | | | | | | | | | | |
| double bond | | | | | | | | | | |

MDR at 180° C. for 25 min

| | | | | | | | | | | |
|---|---|---|---|---|---|---|---|---|---|---|
| ML, dN*m | 0.01 | 0.06 | 0.01 | 0.05 | 0.01 | 0.04 | 0.01 | 0.06 | 0.01 | 0.06 |
| MH, dN*m | 6.31 | 5.6 | 6.37 | 4.2 | 2.0 | 0.79 | 4.26 | 4.1 | 4.79 | 3.98 |
| MH-ML, | 6.3 | 5.54 | 6.36 | 4.15 | 1.99 | 0.75 | 4.25 | 4.04 | 4.78 | 3.92 |
| dN*m | | | | | | | | | | |
| T90, min | 11.51 | 8.72 | 11.8 | 13.24 | 18.55 | 17.1 | 3.9 | 5.05 | 3.33 | 6.84 |
| TS1 | 2.78 | 1.99 | 2.94 | 3.17 | 8.51 | / | 1.39 | 1.43 | 1.2 | 2.02 |

1. A process to form a crosslinked composition, the process comprising thermally treating a composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

2. The process of claim 1, wherein the interpolymer of component a is an ethylene/alpha-olefin/silane interpolymer.

3. The process of claim 1, wherein the interpolymer of component a comprises, in polymerized form, ≥0.10 wt % of the silane, based on the weight of the interpolymer.

4. The process of claim 1, wherein the interpolymer of component a comprises, in polymerized form, ≤40 wt % of the silane, based on the weight of the interpolymer.

5. The process of claim 1, wherein the composition is thermally treated at a temperature ≥120° C.

6. A crosslinked composition formed by the process of claim 1.

7. A composition that comprises the following components:
a) at least one olefin/silane interpolymer comprising at least one Si—H group,
b) at least one peroxide, and
c) at least one crosslinking coagent,
wherein the composition has a mole ratio of active oxygen atom to carbon-carbon double bond of ≥0.02 and ≤0.7, based on the active oxygen atom content of component b and the carbon-carbon double bond content of component c.

8. The composition of claim 7, wherein the olefin/silane interpolymer of component a is an ethylene/alpha-olefin/silane interpolymer.

9. The composition of claim 7, wherein the silane is derived from a silane
monomer selected from Formula 1:
A-(SiBC—O)ₓ—Si-EFH (Formula 1),
where A is an alkenyl group;
B is a hydrocarbyl group or hydrogen, C is a hydrocarbyl group or hydrogen, and where B and C may be the same or different;
H is hydrogen, and x≥0;
E is a hydrocarbyl group or hydrogen, F is a hydrocarbyl group or hydrogen, and where E and F may be the same or different.

10. The composition of claim 7, wherein Formula 1 is selected from the following compounds s1) through s16) below:

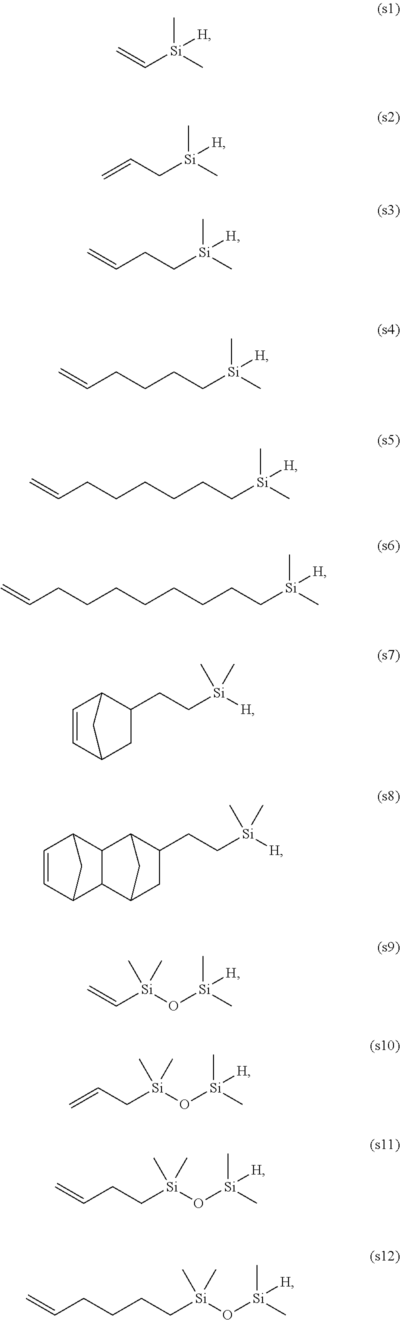

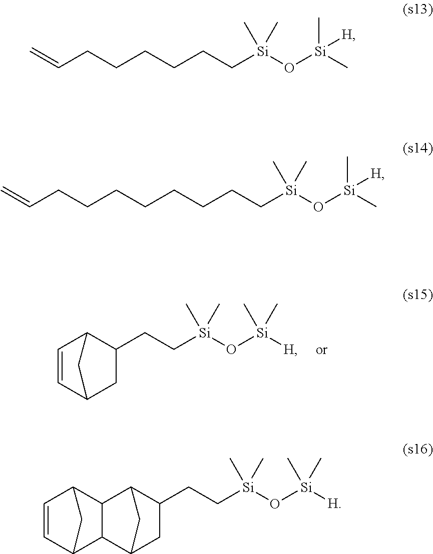

11. The composition of claim 7, wherein the composition has a weight ratio of component c to component b of ≥0.7.

12. The composition of claim 7, wherein the composition has a weight ratio of component c to component b of ≤100.0.

13. The composition of claim 7, wherein the composition has a weight ratio of component a to component b ≥100.

14. The composition of claim 7, wherein the composition has a weight ratio of component a to component b ≤3000.

15. An article comprising at least one component formed from the composition of claim 7.
